(19) United States
(12) Patent Application Publication
(10) Pub. No.: US 2025/0345752 A1
(43) Pub. Date: Nov. 13, 2025

(54) CERAMIC MEMBRANE PREPARED BY 3D PRINTING TECHNOLOGY AND THE PREPARATION METHOD THEREOF

(71) Applicant: NATIONAL TAIPEI UNIVERSITY OF TECHNOLOGY, Taipei (TW)

(72) Inventors: Shiao-Shing CHEN, Taipei (TW); Mithilesh PASAWAN, Taipei (TW); Bhanupriya DAS, Taipei (TW)

(21) Appl. No.: 18/882,793

(22) Filed: Sep. 12, 2024

(30) Foreign Application Priority Data
May 8, 2024 (TW) 113117077

(51) Int. Cl. B01D 67/00; B01D 69/02; B01D 71/02; B33Y 80/00; C02F 1/44; C02F 103/30

(52) U.S. Cl. CPC B01D 67/00415; B01D 67/0088; B01D 69/02; B01D 71/025; B01D 71/027; B01D 71/0281; B33Y 80/00; C02F 1/444; B01D 2323/02; B01D 2323/04; B01D 2323/081; B01D 2325/02; B01D 2325/04; B01D 2325/08; C02F 2103/30

(57) ABSTRACT

The present disclosure provides a ceramic membrane prepared by 3D printing technology, comprising Al₂O₃·2SiO₂ and/or Na₈[AlSiO₄]₆(OH)₂, or hydrates thereof. The overall thickness of the ceramic membrane is from 0.01 cm to 1.5 cm, and the ceramic membrane contains 70 wt % to 85 wt % of silicon. According to the ceramic membrane and the preparation method thereof of the present disclosure, the ceramic membrane may operate under harsh chemical conditions and may be widely applied in various applications such as wastewater treatment and microbial fuel cells.

### CROSS-REFERENCE TO RELATED APPLICATIONS

This application claims the benefit of priority of Taiwan Application Number TW113117077, filed on 8 May 2024, which is herein incorporated by reference in its entirety.

### TECHNICAL FILED

The present disclosure relates to a ceramic membrane prepared by 3D printing technology and a method for preparing the same.

### BACKGROUND

The continuous combustion of coal to meet the energy demands of the global population has led to increasing environmental concerns due to the byproduct, coal ash. Coal ash is solid waste rich in silicon (Si) and aluminum (Al). Therefore, coal ash waste may be recycled and utilized to produce zeolites and subsequent products, thereby alleviating the environmental burden caused by the disposal of coal ash waste while achieving a positive energy cycle. However, traditional synthesis methods for producing zeolites from coal ash are very complex, and there is still a need to develop techniques for producing high-purity zeolites with an ideal Si/Al ratio and particle size range.

Additionally, due to important benefits such as the chemical and thermal stability of ceramic membrane, low fouling propensity, long lifespan, and the ability to address the problems associated with the high cost and toxicity of fluorinated compounds in many ion exchange membranes, ceramic membranes have become increasingly popular in industries such as water treatment.

However, there have been no related inventions targeting technologies that may reutilize coal ash waste to prepare ceramic membranes and further control the desired silicon content, thickness, porosity, and hydrophilicity/hydrophobicity of the ceramic membranes through the manufacturing process.

### SUMMARY

The present disclosure aims to prepare ceramic membranes with desired silicon content, thickness, porosity, and hydrophilicity/hydrophobicity.

The present disclosure provides a zeolite prepared from coal ash, comprising hydroxy-sodalite with the following chemical formula:

Na₈[AlSiO₄]₆(OH)₂

The Si/Al ratio of the zeolite is from 1.1 to 1.9; the zeolite is synthesized from coal fly ash and/or coal bottom ash through a hydrothermal method at a lower temperature without stirring. The particle size of the coal fly ash ranges from 0.1 μm to 3.0 μm, and the particle size of the coal bottom ash ranges from 0.05 μm to 2.0 μm. In one embodiment, when only coal fly ash is used for synthesis, the particle size of the synthesized zeolite ranges from 0.01 μm to 0.50 μm, and the Si/Al ratio is from 1.7 to 1.9. In one embodiment, when only coal bottom ash is used for synthesis, the particle size of the synthesized zeolite ranges from 0.01 μm to 1.00 μm, and the Si/Al ratio is from 1.1 to 1.3. Compared to the original coal fly ash and coal bottom ash particles, the hydroxy-sodalite extracted from coal fly ash and/or coal bottom ash particles has a relatively loose crystal structure, thus significantly increasing the surface area and improving adsorption properties.

The present disclosure also provides a ceramic membrane prepared by 3D printing technology, comprising compounds Al₂O₃·2SiO₂ and/or Na₈[AlSiO₄]₆(OH)₂, or hydrates thereof. The overall thickness of the ceramic membrane is from 0.01 cm to 1.5 cm, and the silicon content of the ceramic membrane is from 70 wt % to 85 wt %. In one embodiment, the ceramic membrane is hydrophilic or superhydrophilic. In one embodiment, the ceramic membrane is hydrophobic or superhydrophobic. In one embodiment, the 3D printing thickness of each layer of the ceramic membrane is from 5 μm to 500 μm. Therefore, the present disclosure utilizes 3D printing technology to design self-supported ceramic membranes with controllable thickness and pore size, thereby expanding the application range of economically viable ceramic membranes. The ceramic membrane of the present disclosure demonstrates its feasibility in actual wastewater treatment, and it may be well integrated into industrial applications for treating municipal sewage and high-strength wastewater, thus contributing to wastewater management. The ceramic membrane of the present disclosure is also a promising material for use as a separator layer in microbial fuel cell devices, which may simultaneously treat wastewater and generate electricity, serving people in remote areas around the world who do not have access to clean water and electricity.

In one embodiment, the ceramic membrane is prepared by a slurry containing coal ash (68.14 wt %), photopolymer resin (ULC F6) (21.37 wt %), solvent (methanol) (9.35 wt %), dispersant (model number 2145) (1.09 wt %), orange pigment (model number 243) (0.04 wt %).

The present disclosure also provides a method for preparing the ceramic membrane, comprising the following steps:

mixing a silicon-aluminum-based material, photopolymer resin, solvent, dispersant, and pigment to form a mixture, wherein the silicon-aluminum-based material is at least one selected from a group consisting of coal fly ash, coal bottom ash, zeolite containing hydroxy-sodalite, and combinations thereof; ball-milling the mixture to form a ball-milled mixture; irradiating the ball-milled mixture to perform photocuring 3D printing, and then drying the printed product. In one embodiment, the method further comprises steps of debinding and sintering the printed product. In one embodiment, the method further comprises steps of altering the hydrophilicity/hydrophobicity of the ceramic membrane.

The ceramic membrane of the present disclosure, prepared by 3D printing technology, possesses desirable properties such as adjustable silicon content, thickness, porosity, and hydrophilicity/hydrophobicity, making it suitable for various industrial applications.

### BRIEF DESCRIPTION OF THE DRAWINGS

FIG. 1 shows a diagram illustrating the mechanism of synthesizing zeolite from coal ash via hydrothermal synthesis.

FIG. 2A shows SEM image of the coal fly ash, FIG. 2B shows SEM image of the

zeolite prepared from coal fly ash, FIG. 2C shows SEM image of the coal bottom ash, and FIG. 2D shows SEM image of the zeolite prepared from coal bottom ash.

FIG. 3 shows the effect of dispersant concentration on the viscosity of the slurry.

FIG. 4 shows a time-temperature chart of the debinding to sintering process.

FIG. 5A shows the results of ceramic membranes prepared from coal fly ash at different sintering temperatures, and FIG. 5B shows the results of ceramic membranes prepared from coal bottom ash at different sintering temperatures.

FIG. 6 illustrates the effect of sintering temperature on the porosity of ceramic membranes prepared from coal fly ash and coal bottom ash.

FIG. 7 is a diagram showing the process of altering the hydrophilicity/hydrophobicity of the ceramic membrane.

FIG. 8 shows the effect of immersion in various concentrations of PDMS on the hydrophilicity/hydrophobicity of ceramic membranes prepared from coal fly ash and coal bottom ash.

FIG. 9A shows the particle size distribution of denim jeans industry wastewater, FIG. 9B shows the variation of water flux over time (T=25° C., TMP=0.5 bar), FIG. 9C show the total dissolved solids (TDS) from the removal of wastewater within 1 hour, FIG. 9D show the turbidity (NTU) from the removal of the wastewater within 1 hour, FIG. 9E shows the coal ash membrane before wastewater treatment, FIG. 9F shows the membrane with a cake layer formed after wastewater treatment, which may be scraped off and reused, FIG. 9G shows photographs of the wastewater before and after ultrafiltration (UF) treatment, showing the color removal, FIG. 9H shows the contact angle suitable for ultrafiltration applications, proving the superhydrophilicity of the coal ash membrane, and FIG. 9I shows a table of the removal rates of COD, TDS, and NTU before and after wastewater treatment.

FIG. 10 represents graphs showing the flux, separation factor, and time relationship when using the ceramic membrane of the present disclosure as a pervaporation membrane.

FIG. 11 represents diagrams illustrating the electrical characteristics of a microbial fuel cell using the ceramic membrane of the present disclosure.

### DETAILED DESCRIPTION

The present disclosure will be described with figures and embodiments. It should be understood that the following embodiments are only for describing and explaining the content of the present disclosure and are not intended to limit the scope of the present disclosure and claims.

The present disclosure provides a ceramic membrane prepared by 3D printing technology, which reutilizes waste materials such as coal fly ash (CFA) and coal bottom ash (CBA) byproducts resulting from coal-fired power generation (herein also referred to as coal ash, which may be one or more selected from CFA and CBA). The 3D printing may be carried out using Solvent-based Slurry Stereolithography (3S), a technique effective for layer-by-layer fabrication of membranes and capable of building three-dimensional freeform objects with high precision and surface quality based on the operating parameters and working mechanisms, such as rheological behavior, particle size, powder morphology, and layer thickness. The Solvent-based Slurry Stereolithography is suitable for the large-scale manufacturing of self-supported membranes for industrial applications. The slurry used for 3D printing in the present disclosure comprises slurry directly prepared from coal ash, slurry directly prepared from zeolite, or slurry prepared from a mixture of coal ash and zeolite.

The coal fly ash (CFA) and coal bottom ash (CBA) used in the present disclosure are byproducts generated from coal-fired power generation, which may contain oxides and trace elements such as SiO₂, Al₂O₃, Fe₂O₃, CaO, MgO, P₂O₅, SO₃, Mn₃O₄, TiO₂, BaO, SrO, Na₂O, K₂O. The particle size of the coal fly ash may range from 0.1 μm to 3.0 μm, preferably from 0.2 μm to 3.0 μm, more preferably from 0.217 μm to 2.822 μm, and even more preferably about 0.76 μm. The particle size of the coal bottom ash may range from 0.05 μm to 2.0 μm, preferably from 0.07 μm to 1.8 μm, more preferably from 0.098 μm to 1.29 μm, and even more preferably about 0.56 μm. The coal fly ash may contain 50 wt % to 60 wt % of SiO₂ and 20 wt % to 30 wt % of Al₂O₃, while the coal bottom ash may contain 40 wt % to 55 wt % of SiO₂ and 10 wt % to 25 wt % of Al₂O₃. The specific surface area of the coal fly ash may range from 0.5 m²/g to 1.5 m²/g, and the specific surface area of the coal bottom ash may range from 0.6 m²/g to 1.6 m²/g. The Si/Al ratio of the coal fly ash may range from 1.3 to 2.0, preferably from 1.5 to 1.8, and more preferably about 1.7. The Si/Al ratio of the coal bottom ash may range from 1.5 to 2.2, preferably from 1.6 to 2.0, and more preferably about 1.8. The coal fly ash and coal bottom ash used in the present disclosure have high purity and crystallinity.

Table 1 shows an example of the composition of coal fly ash and coal bottom ash.

TABLE 1

Amount

| Oxides/trace elements | unit | CFA | CBA |
|---|---|---|---|
| SiO₂ | wt % | 54.94 | 49.67 |
| Al₂O₃ | wt % | 25.77 | 19.96 |
| Fe₂O₃ | wt % | 5.94 | 3.90 |
| CaO | wt % | 3.16 | 13.22 |
| MgO | wt % | 2.51 | 1.59 |
| P₂O₅ | wt % | 0.33 | 0.33 |
| SO₃ | wt % | 0.50 | 7.29 |
| Mn₃O₄ | wt % | 0.10 | <0.10 |
| TiO₂ | wt % | 0.99 | 0.86 |
| BaO | wt % | 0.14 | <0.10 |
| SrO | wt % | <0.10 | <0.10 |
| Na₂O | wt % | 1.67 | 0.35 |
| K₂O | wt % | 2.83 | 2.53 |
| Loss on ignition, LOI (600° C.) | % | 1.4 | — |
| Specific surface area | m²/g | 0.984 | 1.1 |

### Pre-Treatment of Coal Fly Ash and/or Coal Bottom Ash

In one embodiment, the present disclosure involves pre-treating coal fly ash and/or coal bottom ash to control properties such as particle size, specific surface area, purity, and crystallinity of the coal fly ash and/or coal bottom ash. At present, coal fly ash is pre-treated by sieving, for example, with a mesh size of 63.0 μm, to control the uniformity of the particles; coal bottom ash is first ground, then calcined at 500° C. for 3 hours, followed by further grinding and sieving, for example, with a mesh size of 63.0 μm.

Through the pre-treatment steps, the properties such as particle size, specific surface area, purity, and crystallinity of the coal fly ash and/or coal bottom ash may be better controlled within the desired range. Thus, coal ash may form a homogeneous mixture, which is advantageous for subsequent printing processes. Additionally, coal fly ash particles may be controlled to be smooth microspheres, and coal bottom ash particles, after pre-treatment, may become fine particles with irregular surface textures.

### Synthesis of Zeolite

Currently, the most widely used method for zeolite synthesis is the hydrothermal (HT) synthesis method, which uses water as a reactant at a temperature of 140° C. and atmospheric pressure conditions. Because the reaction proceeds under controlled atmospheric conditions, the resulting product is of high purity with no byproducts, and energy consumption and environmental impact are minimized, making this one of the most widely adopted methods for producing zeolites utilizing alkaline solutions (NaOH).

In one embodiment, the present disclosure uses the hydrothermal method to synthesize zeolites. Furthermore, the present disclosure employs an improved hydrothermal synthesis method, which may reduce the synthesis temperature and produce synthetic zeolites with higher conversion rates and better crystallinity. For example, compared to prior art methods, the present disclosure uses a sealed vessel made of Teflon used in the steel autoclave, which may automatically lower the synthesis temperature.

The method for synthesizing zeolite involves treating coal ash samples with an alkaline solution, melting them at a temperature of 140° C., and then performing a conventional heating process without stirring. In a specific embodiment, coal ash is treated with 5M sodium hydroxide (NaOH), stirred at 800 rpm while being aged at 70° C. for 1.5 hours; then, the mixture is placed in a sealed vessel made of Teflon in the steel autoclave for hydrothermal synthesis at 140° C. for 48 hours, followed by conventional heating without stirring. Next, the synthesized zeolite is washed with distilled water to a pH of 10, then dried in an oven at 70° C. for 24 hours to obtain hydroxy-sodalite zeolite prepared from coal ash. This zeolite may be further ground to facilitate the subsequent preparation of the ceramic membrane.

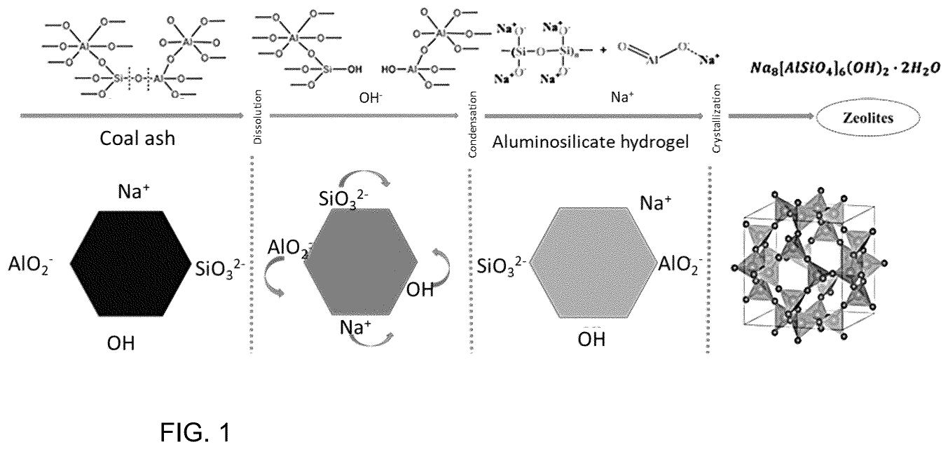

FIG. 1 is a diagram illustrating the mechanism of synthesizing zeolite from coal ash via hydrothermal synthesis. As shown in FIG. 1, the mechanism of hydrothermal synthesis of zeolite from coal ash includes dissolution, condensation, and crystallization reactions. The first step involves the breaking of Si—O—Si and Al—O—Si covalent bonds transforming itself into a colloidal solution After this process, the cleaved structures unite with time, forming and generating a condensed structure. As time progresses, the temperature crystallization process leads to the development of polymorphic structures of NazSiOs and NaAlO₂. The following reaction equations (1) and (2) represent the dissolution, condensation, and crystallization reactions from step 1 to step 3 in FIG. 1. Ultimately, the target product hydroxy-sodalite zeolite may be obtained.

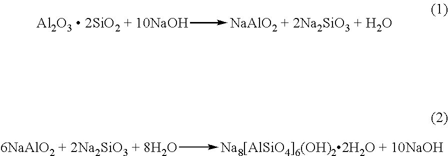

The particle size of the zeolite prepared from coal fly ash may range from 0.01 μm to 0.50 μm, preferably from 0.02 μm to 0.4 μm, more preferably from 0.031 μm to 0.396 μm, and even more preferably about 0.12 μm; the Si/Al ratio of the zeolite may range from 1.7 to 1.9, preferably about 1.8. The particle size of the zeolite prepared from coal bottom ash may range from 0.01 μm to 1.5 μm, preferably from 0.02 μm to 1.0 μm, more preferably from 0.035 μm to 0.856 μm, and even more preferably about 0.22 μm; the Si/Al ratio of the zeolite may range from 1.1 to 1.3, preferably about 1.2. By optimizing the particle size of these zeolites, a homogeneous mixture may be formed, which is advantageous for subsequent printing processes.

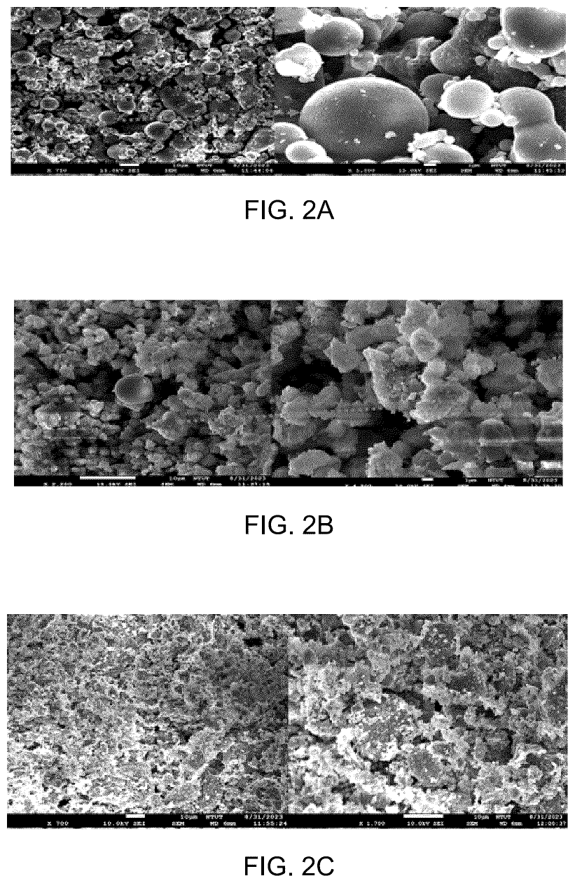

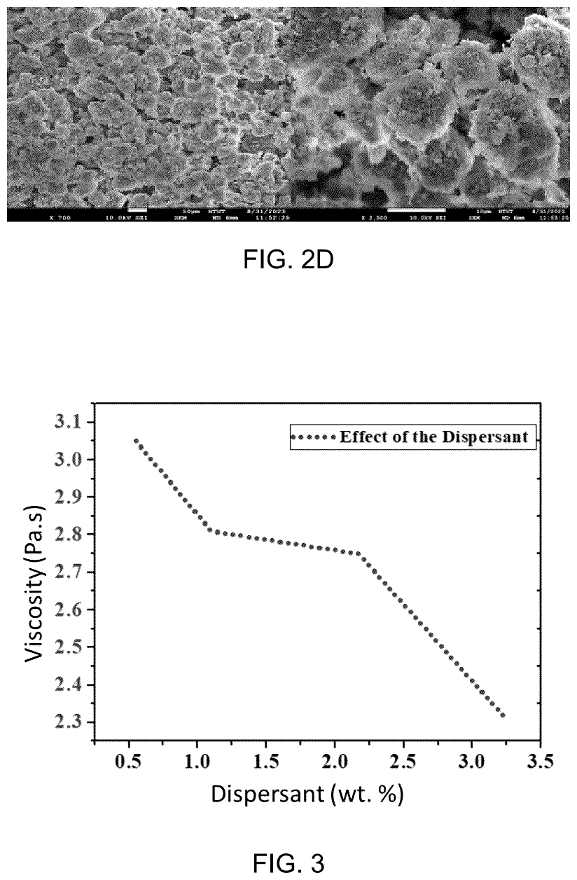

Furthermore, after the alkalinization reaction, the zeolite obtained from coal ash exhibits a flower-like morphology, with a relatively loose structure, high crystallinity, and large specific surface area. The properties of the synthesized samples are related to the hydrothermal synthesis time, allowing different degrees of crystallinity and smooth surfaces to be achieved by adjusting the synthesis time, which is a prerequisite for fabricating membranes using 3D printing technology. FIG. 2A, FIG. 2B, FIG. 2C and FIG. 2D shows SEM images of coal fly ash, zeolite prepared from coal fly ash, coal bottom ash, and zeolite prepared from coal bottom ash, respectively.

The following Table 2 presents an example of the elemental concentration (mg/kg) of coal fly ash, coal bottom ash, and the hydrothermal synthesized zeolites prepared from them.

TABLE 2

| | | | | Zeolite prepared |
|---|---|---|---|---|
| | coal | coal | Zeolite prepared | from coal |
| Element | fly ash | bottom ash | from coal fly ash | bottom ash |
| C | 0.00 | 0.00 | 72.23 | 0.00 |
| F | 8.44 | 3.69 | 6.44 | 0.00 |
| Na | 2.71 | 1.93 | 3.98 | 12.29 |
| Mg | 1.68 | 1.43 | 0.30 | 0.54 |
| Al | 23.60 | 18.91 | 4.86 | 17.38 |
| Si | 39.77 | 34.39 | 6.20 | 31.76 |
| P | 0.49 | 0.15 | 0.00 | 0.00 |
| S | 0.00 | 3.67 | 0.04 | 3.56 |
| K | 4.21 | 4.41 | 0.32 | 1.96 |
| Ca | 2.54 | 17.54 | 1.28 | 18.96 |
| Ti | 1.18 | 1.47 | 0.32 | 1.09 |
| Cr | 0.44 | 0.04 | 0.35 | 0.07 |
| Mn | 0.27 | 0.00 | 0.00 | 0.86 |
| Fe | 11.12 | 7.05 | 2.30 | 5.49 |
| Co | 0.00 | 0.00 | 0.10 | 0.29 |
| Ni | 0.62 | 0.97 | 0.17 | 0.13 |
| Cu | 0.00 | 0.17 | 0.00 | 0.00 |
| Zn | 0.00 | 0.00 | 1.03 | 2.14 |
| As | 0.06 | 0.32 | 0.00 | 1.22 |
| Mo | 2.86 | 3.83 | 0.08 | 0.00 |
| Pd | 0.00 | 0.00 | 0.00 | 0.11 |
| Ag | 0.00 | 0.04 | 0.00 | 0.52 |
| Cd | 0.00 | 0.00 | 0.00 | 0.87 |
| Sn | 0.00 | 0.00 | 0.00 | 0.74 |

### Preparation of Ceramic Membrane

### Method for Preparing Slurry for 3D Printing

The slurry used for 3D printing in the present disclosure comprises silicon-aluminum-based materials, including slurry directly prepared from coal fly ash and/or coal bottom ash, slurry directly prepared from zeolite, or slurry prepared from a mixture of coal ash and zeolite. The preparation formula may include adding silicon-aluminum-based materials to sodium hydroxide (98%), methanol (99%), photopolymer resin F6, inorganic dispersant, and orange pigment.

As a specific example of the slurry preparation formula, coal ash and/or zeolite (content: 68.14 wt %) may be mixed with methanol (as a solvent, content: 9.35 wt %). The slurry forms green parts under light exposure. To increase the density of the green parts, photopolymer resin F6 (content: 21.38 wt %), inorganic dispersant (model 2145) (content: 1.1 wt %), and orange pigment (model 243) (content: 0.04 wt %) are added. The aforementioned materials are mixed in the specified content ratios to form the slurry for 3D printing.

### Ball Milling Step

The prepared slurry is stored in a cylindrical container containing zirconia balls (150-160 grams), followed by ball milling. The ball milling is conducted at room temperature, rotating the container at a speed of 20 rpm for 24 hours. It is observed that after the ball milling, the viscosity of the slurry prepared from zeolite derived from coal ash is higher than that of coal ash slurry due to its rough surface and smaller particle size.

Specifically, dispersants may be used to uniformly distribute coal ash and/or zeolite particles to achieve suitable viscosity. The concentration of the dispersant may range from 0.55 wt % to 3.22 wt %; however, when the concentration of the dispersant is 1.1 wt %, the slurry viscosity is optimal. FIG. 3 shows the effect of dispersant concentration on the viscosity of the slurry. This may control the viscosity of the slurry after ball milling. For example, the viscosity of coal fly ash slurry may range from 1.5 Pa.s to 3.0 Pa.s, preferably 2.11 Pa.s; the viscosity of coal bottom ash slurry may range from 2.0 Pa.s to 3.5 Pa.s, preferably 2.81 Pa.s; the viscosity of the slurry prepared from zeolite derived from coal fly ash may range from 4.0 Pa.s to 5.5 Pa.s, preferably 4.67 Pa.s; and the viscosity of the slurry prepared from zeolite derived from coal bottom ash may range from 2.5 Pa.s to 4.0 Pa.s, preferably 3.2 Pa.s. These viscosity measurements indicate that the optimal slurry viscosity suitable for additive manufacturing without defect to print was obtained, which is advantageous for developing 3D printed ceramic membranes and may be an efficient method for large-scale manufacturing of sub-micron-thick membranes.

### 3D Printing Step

According to one embodiment of the present disclosure, the 3D printing of ceramic membranes is carried out using Solvent-based Slurry Stereolithography (3S). The 3S system may include a DLP (Direct Light Processing) system, which is set to project blue light with a visible spectrum of 800 nm. In one embodiment, the light exposure times for the various materials may be as follows: 1.2 seconds for the slurry of coal fly ash, 4 seconds for the slurry of coal bottom ash, 6 seconds for the slurry prepared from zeolite derived from coal fly ash, and 8.5 seconds for the slurry prepared from zeolite derived from coal bottom ash.

The 3D manufacturing process involves analyzing the rheological behavior of the slurry, then designing the membrane in 3D modeling by adjusting the thickness and surface pattern of the membrane, and subsequently performing 3D printing.

The designed ceramic membrane may be a disc-shaped self-supported membrane with at least one patterned disc surface. Preferably, the patterning on the disc surface may include shapes of circular, elliptical, triangular, rectangular, honeycomb, polygonal, and other shapes. Additionally, the 3D printed ceramic membrane may include subsequent debinding and sintering steps as needed.

The designed ceramic membrane may have a diameter ranging from 25 cm to 40 cm, for example, 32 cm. The overall thickness may range from 0.01 cm to 1.5 cm, preferably from 0.05 cm to 1.0 cm, and more preferably from 0.1 cm to 0.3 cm, with each layer of the ceramic membrane having a printed thickness of 30 μm.

After completing the 3D printing, the membrane undergoes ultrasonic treatment for 5 minutes to remove unbound particles, and is further dried at room temperature. Consequently, the ceramic membrane may contain compounds Al₂O₃·2SiO₂ and/or Na₈[AlSiO₄]₆(OH)₂, or hydrates thereof.

### Debinding and Sintering Steps

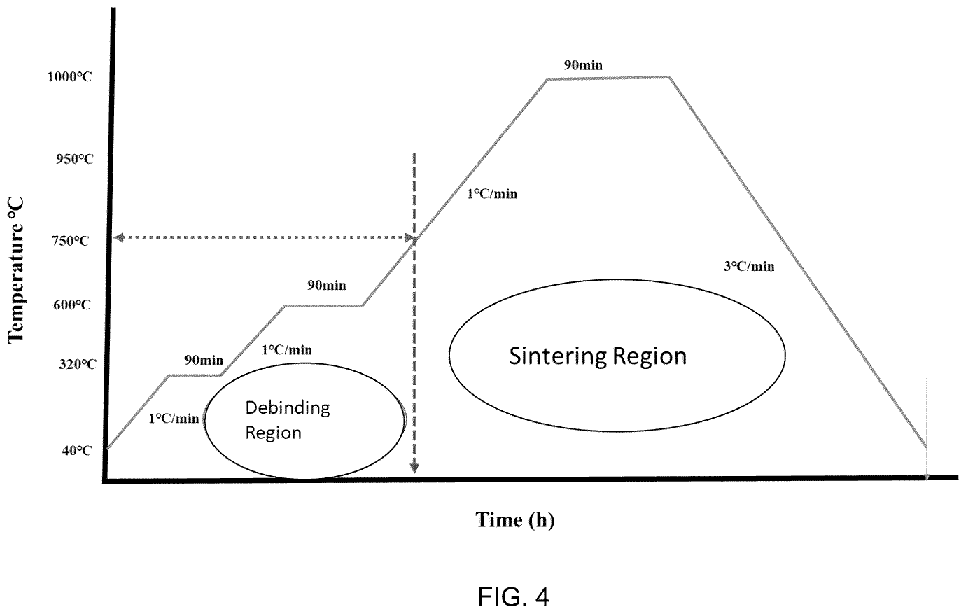

According to one embodiment of the present disclosure, the ceramic membranes prepared from coal fly ash and coal bottom ash are further subjected to debinding and sintering steps. FIG. 4 illustrates an example of the time-temperature profile for the debinding and sintering process. In the debinding and sintering steps, a muffle furnace may be used for sintering. The sintering temperature for the ceramic membrane prepared from coal ash may range from 700° C. to 1100° C., with a sintering rate of 1° C./min and a cooling rate of 3° C./min. Sintering starts from 40° C., reaches the maximum temperature, and then cools down to 40° C. Consequently, the ceramic membrane may contain compounds Al₂O₃·2SiO₂ and/or Na₈[AlSiO₄]₆(OH)₂, or hydrates thereof.

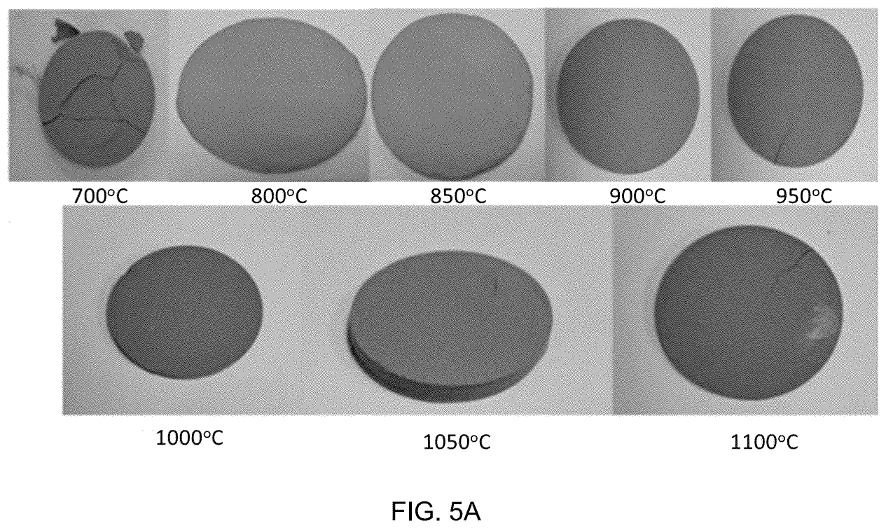

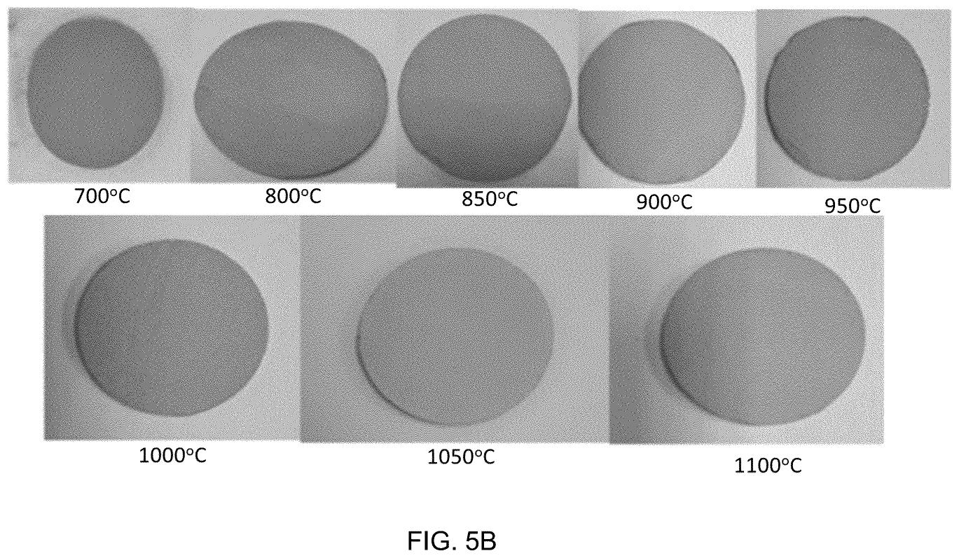

In one embodiment, the ceramic membrane prepared from coal fly ash remains in the debinding temperature range at 700° C. and starts sintering after 700° C. The minimum sintering temperature may be 750° C., preferably above 800° C., with a maximum sintering temperature below 1100° C.; however, the optimal sintering temperature is from 900° C. to 1000°° C. The ceramic membrane prepared from coal bottom ash undergoes debinding at 600° C. and starts sintering after 600° C. The minimum sintering temperature may be above 700° C., with a maximum sintering temperature below 1100° C.; however, considering thermal stability, the optimal sintering temperature is from 850° C. to 950° C. Phase transitions occur when the sintering temperature exceeds the aforementioned maximum temperature, and the linear shrinkage of coal ash particles becomes significant. FIG. 5A and FIG. 5B shows the results of the ceramic membranes prepared from coal fly ash and coal bottom ash at different sintering temperatures.

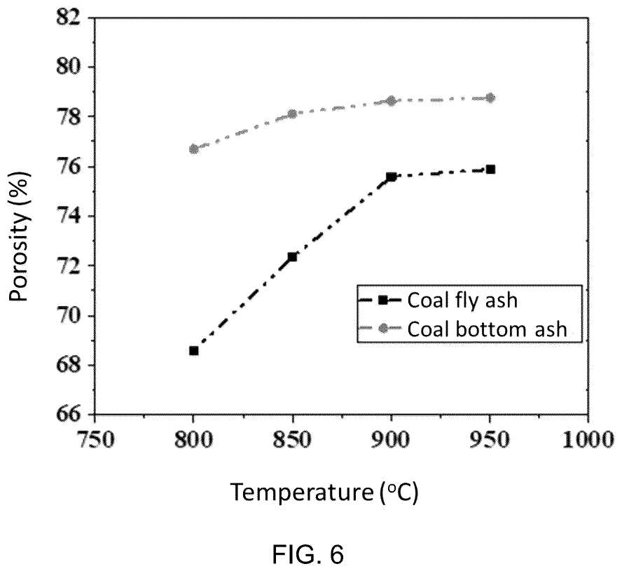

FIG. 6 illustrates the effect of sintering temperature on the porosity of ceramic membranes prepared from coal fly ash and coal bottom ash. In FIG. 6, the horizontal axis represents the sintering temperature, and the vertical axis represents the porosity.

At different temperatures of 850° C., 900° C., 950° C., 1000° C., and 1050° C., the pore sizes of the ceramic membrane prepared from coal fly ash are 1.13 μm, 0.398 μm, 1.13 μm, 1.25 μm, and 1.531 μm, respectively. The pore sizes of the ceramic membrane prepared from coal bottom ash are 0.535 μm, 0.518 μm, 0.595 μm, 0.625 μm, and 0.638 μm, respectively. Therefore, the ceramic membranes prepared from coal fly ash and coal bottom ash are porous membranes. However, the ceramic membranes prepared from zeolite synthesized from coal fly ash and coal bottom ash are non-porous.

In summary, the ceramic membrane of the present disclosure may achieve control over thickness and pore size, thereby expanding the application range of economically viable ceramic membranes.

### Modifying the Hydrophilicity/Hydrophobicity of the Ceramic Membrane

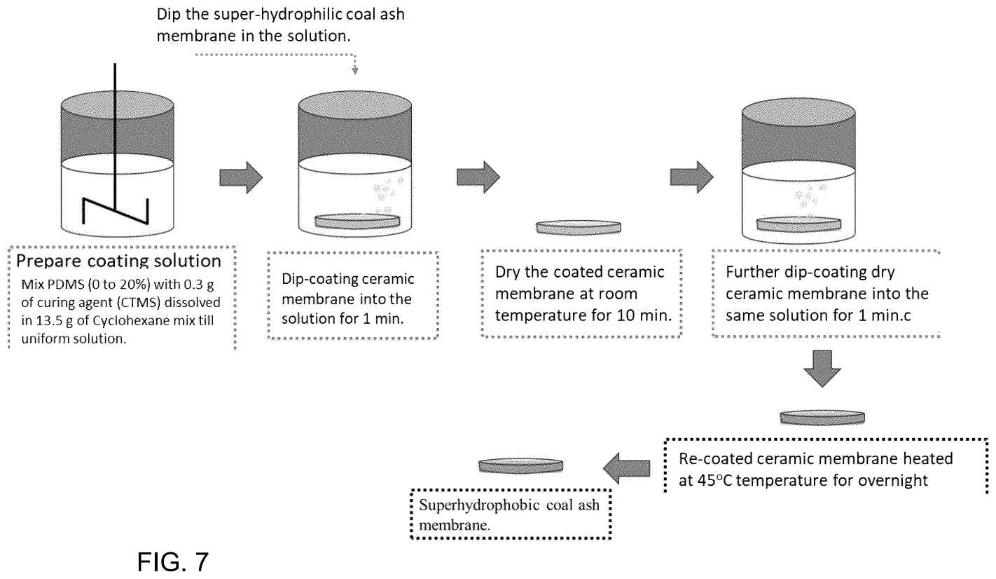

The present disclosure may further include steps for altering the hydrophilicity/hydrophobicity of the ceramic membrane. FIG. 7 is a diagram showing the process of changing the hydrophilicity/hydrophobicity of the ceramic membrane. For example, as shown in FIG. 7, the ceramic membrane prepared by the aforementioned method may be immersed in a solution containing chemicals such as polydimethylsiloxane (PDMS), chloromethyl silane, and cyclohexane for 1 minute, dried at room temperature for 10 minutes, then dip again in the solution for 1 minute after that second coat the membranes and dry at 45° C. temperature for overnight. The concentration of the polydimethylsiloxane in the solution may range from 0.01 wt % to 20.00 wt %.

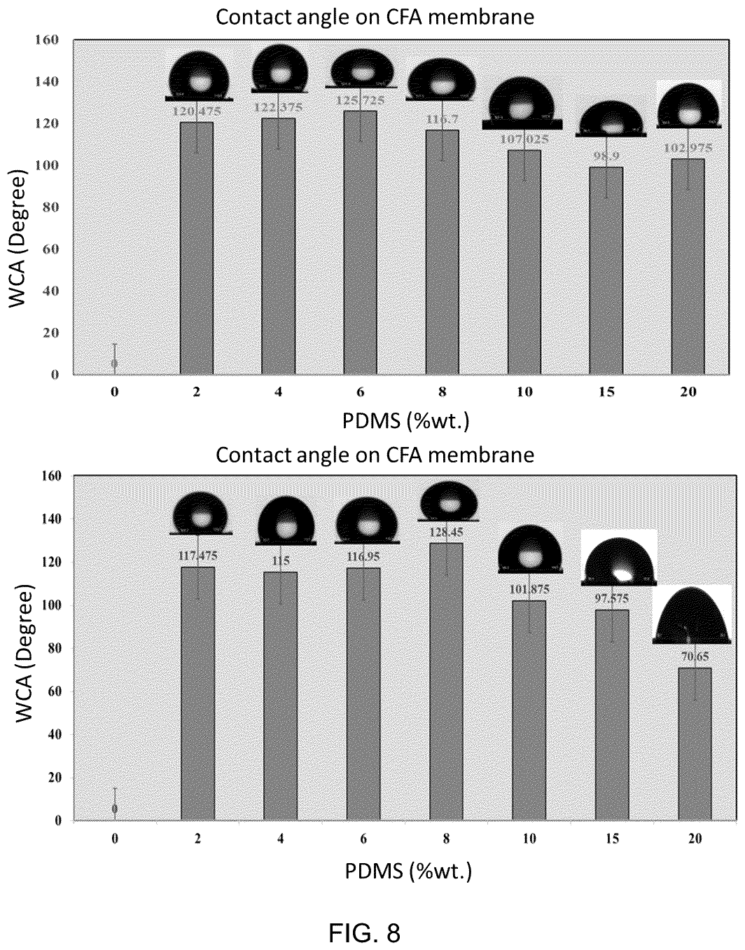

FIG. 8 shows the effect of immersion in various concentrations of PDMS on the hydrophilicity/hydrophobicity of ceramic membranes prepared from coal fly ash and coal bottom ash. In FIG. 8, the horizontal axis represents the wt % of PDMS, and the vertical axis represents the water contact angle (WCA; unit: degrees). As shown in FIG. 8, within the PDMS concentration range of 0-20 wt %, the contact angle values on the ceramic membrane prepared from coal fly ash range from 98.90 to 125.73 degrees, and the contact angle values on the ceramic membrane prepared from coal bottom ash range from 70.65 to 128.45 degrees. Consequently, the wetting properties of the ceramic membranes prepared from coal fly ash and coal bottom ash change from superhydrophilic to superhydrophobic, reaching a contact angle of up to 129 degrees. Accordingly, those skilled in the art may adjust the hydrophilicity/hydrophobicity of the prepared ceramic membranes as needed based on the disclosed content.

### Utilization of Ceramic Membranes

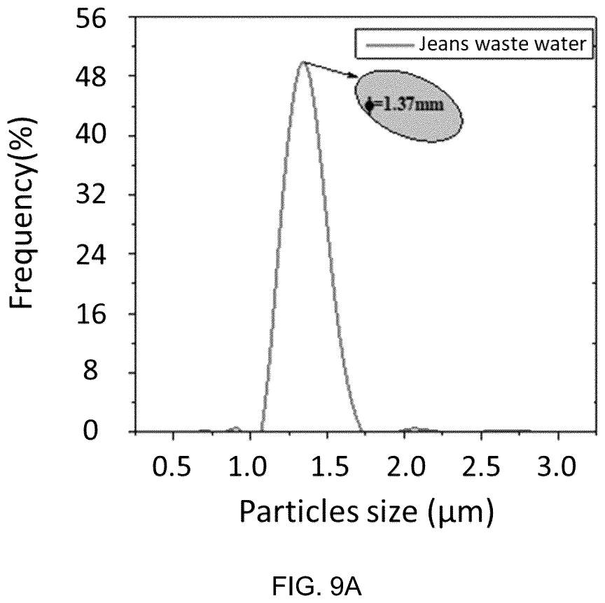

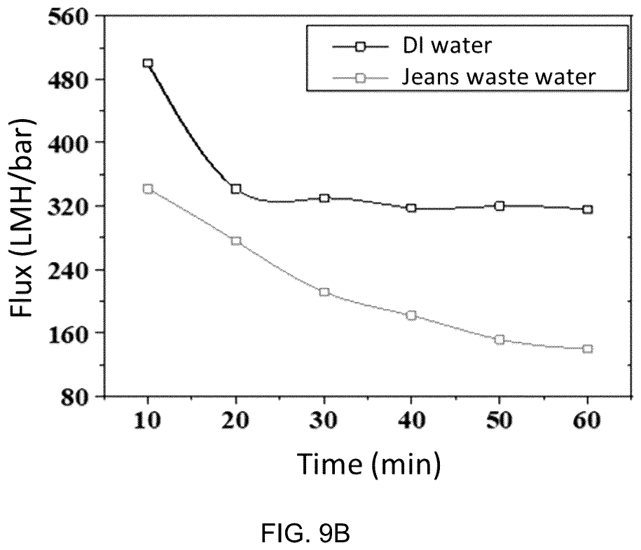

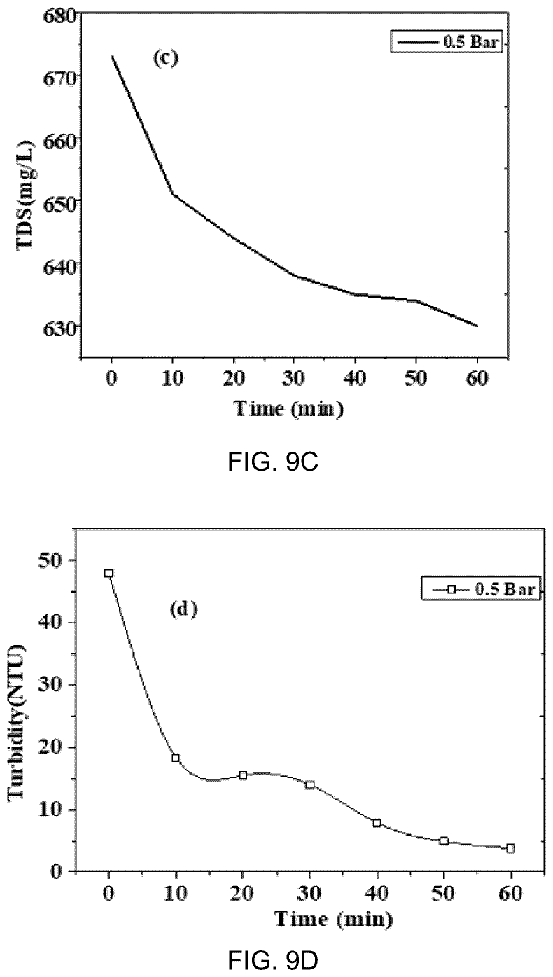

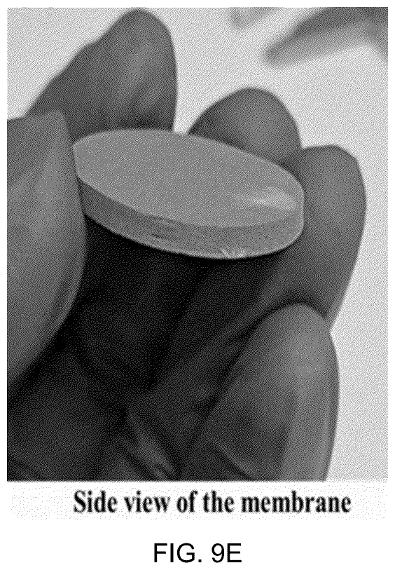

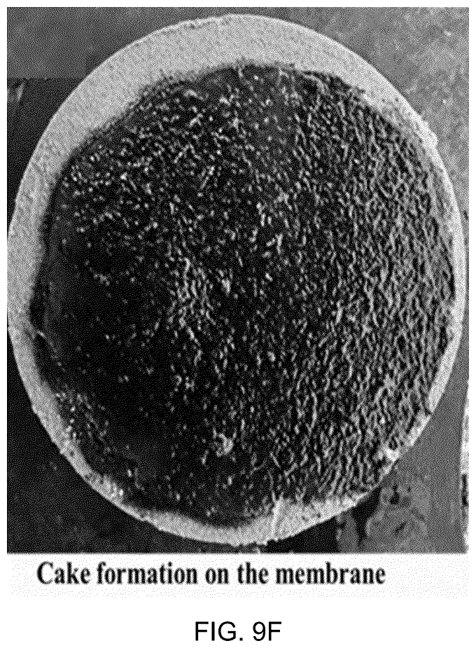

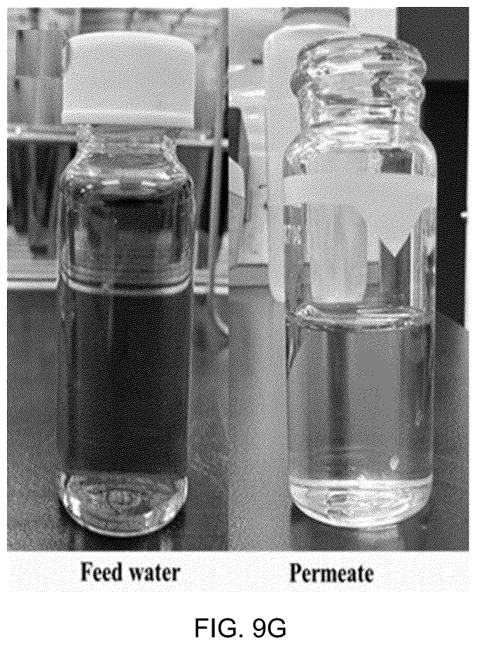

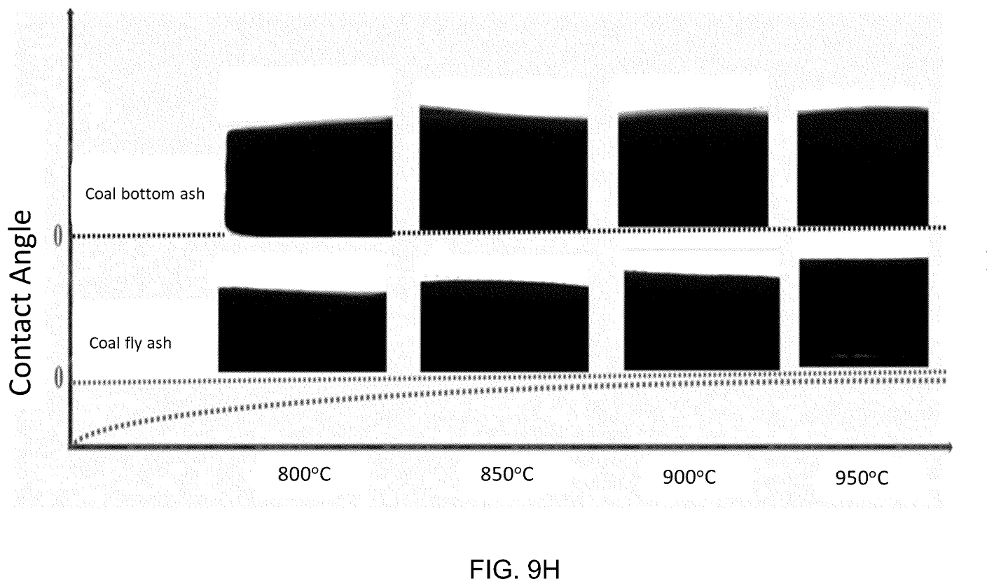

The ceramic membrane prepared in the present disclosure may be used for wastewater treatment. FIG. 9A to FIG. 91 shows the treatment of denim jean industry wastewater using the ceramic membrane of the present disclosure. Specifically, FIG. 9A shows the particle size distribution of denim jeans industry wastewater, FIG. 9B shows the variation of water flux over time (T=25° C., TMP=0.5 bar), FIG. 9C show the total dissolved solids (TDS) from the removal of wastewater within 1 hour, FIG. 9D show the turbidity (NTU) from the removal of the wastewater within 1 hour, FIG. 9E shows the coal ash membrane before wastewater treatment, FIG. 9F shows the membrane with a cake layer formed after wastewater treatment, which may be scraped off and reused, FIG. 9G shows photographs of the wastewater before and after ultrafiltration (UF) treatment, showing the color removal, FIG. 9H shows the contact angle suitable for ultrafiltration applications, proving the superhydrophilicity of the coal ash membrane, and FIG. 91 shows a table of the removal rates of COD, TDS, and NTU before and after wastewater treatment. Accordingly, as shown in FIG. 9A to FIG. 91, after filtration, non-dissolved effluent deposited on the membrane surface are observed and the cake formation started to block the open pore. Specific cake resistance of the ceramic membrane prepared from coal fly ash and the ceramic membrane prepared from zeolite derived from coal fly ash are 2.06×10⁶ m/kg m/kg and 3.9×10⁹ m/kg, respectively, and the membrane resistance values are 2.03×10⁴m⁻¹ and 3.4×10⁵m⁻¹, respectively. Under pressures of 0.5 to 4 bar, the flux decline ratio (FDR) and flux recovery ratio (FRR) for the ceramic membrane prepared from coal fly ash and the ceramic membrane prepared from zeolite derived from coal fly ash are 0.58, 0.70 and 0.44, 0.17, respectively. Accordingly, the ceramic membrane prepared in the present disclosure exhibits superhydrophilicity and complete wetting, making it suitable for high-flux microfiltration and nanofiltration.

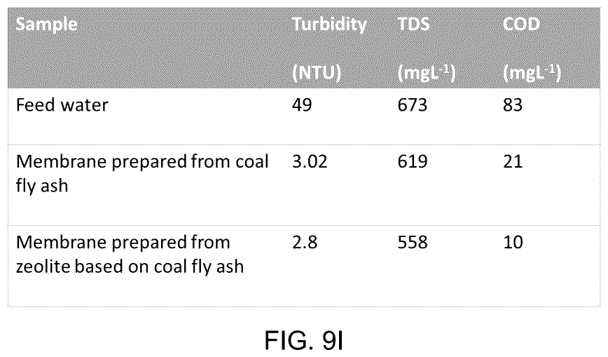

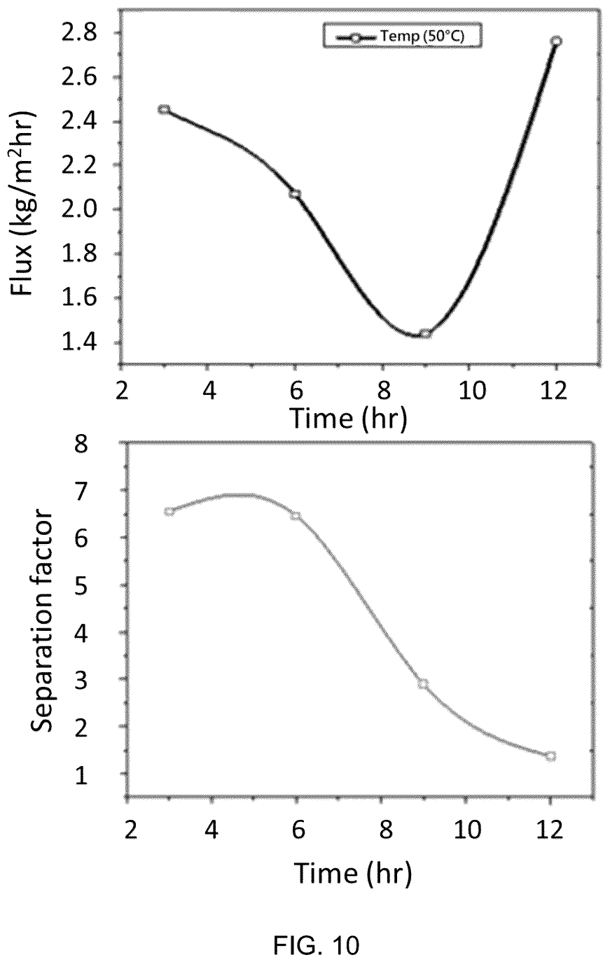

Furthermore, the ceramic membrane prepared in the present disclosure may also be applied as a pervaporation membrane. FIG. 10 illustrates the relationship between flux, separation factor, and time when using the ceramic membrane of the present disclosure as a pervaporation membrane.

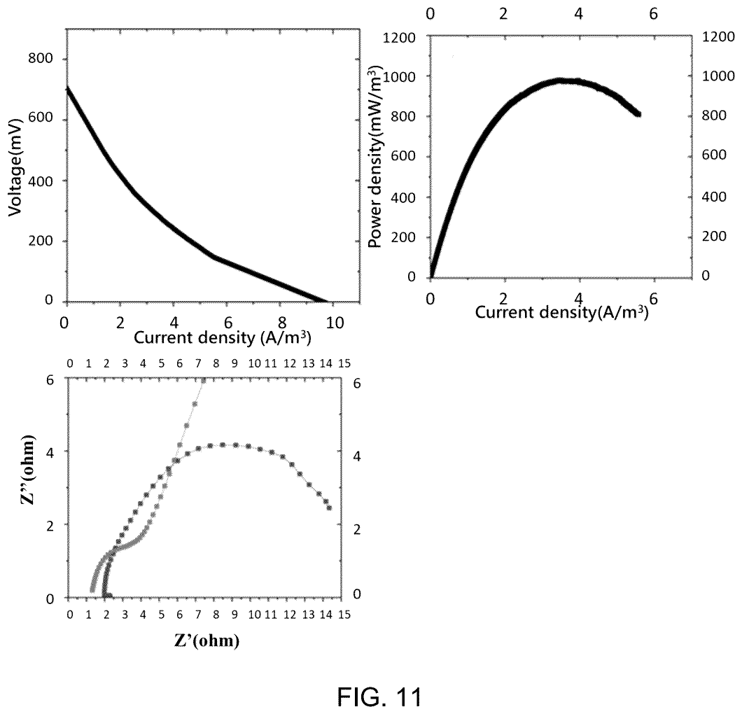

FIG. 11 shows the electrical characteristics of a microbial fuel cell using the ceramic membrane of the present disclosure. Furthermore, as shown in FIG. 11, the ceramic membrane prepared in the present disclosure may be used as a separator layer (proton exchange membrane) in a microbial fuel cell fed with soybean wastewater under an open circuit voltage (OCV) of 722 mV, thereby harvesting energy from the wastewater. Use of coal fly ash as filler material has not only enhanced the proton conductivity in CFA but with efficient pore size distribution the crossover of oxygen into the anode chamber reduced drastically (1.4×10⁻³ cm/s) leading to the development of an active electrogenic bacterial community at anode electrode. The higher OCV for the microbial fuel cell based on coal fly ash reflects the effectiveness of the designed membrane to selectively allow the passage of protons and suppress unfavorable crossover across the membrane. In FIG. 11, the maximum current density of the coal fly ash membrane is 11.76 A/m³, and the maximum power is 977.29 mW/m³. Low ohmic resistance Rₛ of 1.323Ω supports the generation of high-power output and current output values in the microbial fuel cell. The lower charge transfer resistance R_{ct} value of 3.747Ω.in coal fly ash fortifies the potential of electrogenic biofilm to transfer electrons to the solid electrode surface more efficiently indicating the high presence of redox mediators secreted by electrogenic bacteria in the microbial fuel cell based on coal fly ash resulting in efficient electron transfer.

In summary, the present disclosure adopts a hydrothermal method to prepare hydroxy-sodalite from coal fly ash and coal bottom ash, thereby providing an economical method with zero solid waste, significantly reducing the production cost of membranes and making it an economically feasible preparation method. The 3D printing technology utilizes coal ash as a valuable resource that may be commercialized for a wide range of applications from microfiltration to pervaporation. Additionally, using coal ash as a raw material is significant for grasping the economic cycle development of coal and alleviating environmental issues associated with continuous disposal.

The ceramic membrane provided by the present disclosure may operate under harsh chemical conditions, serving as a promising alternative to polymer membranes for selective separation. The ceramic membrane of the present disclosure has adjustable porosity (from dense structures to sub-nano porous structures) and adjustable wettability (from superhydrophilic to superhydrophobic), providing a scientific basis for designing ceramic membranes through 3D printing technology. It may be widely applied in treating complex industrial wastewater using microfiltration to pervaporation applications.

In summary, the present disclosure includes the following aspects:

Aspect 1: A zeolite prepared from coal ash, comprising hydroxy-sodalite with the following chemical formula:

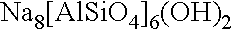

the zeolite has a Si/Al ratio of 1.1 to 1.9;
the zeolite is prepared from coal fly ash and/or coal bottom ash, wherein the coal fly ash has a particle size ranging from 0.1 μm to 3.0 μm, preferably from 0.2 μm to 3.0 μm, more preferably from 0.217 μm to 2.822 μm, and even more preferably about 0.76 μm; the coal bottom ash has a particle size ranges from 0.05 μm to 2.0 μm, preferably from 0.07 μm to 1.8 μm, more preferably from 0.098 μm to 1.29 μm, and even preferably about 0.56 μm.

Aspect 2: The zeolite prepared from coal ash according to Aspect 1, wherein the coal fly ash and/or the coal bottom ash contains oxides and trace elements such as SiO₂, Al₂O₃, Fe₂O₃, CaO, MgO, P₂O₅, SO₃, Mn₃O₄, TiO₂, BaO, SrO, Na₂O, and K₂O.

Aspect 3: The zeolite prepared from coal ash according to any one of the preceding aspects, wherein the coal fly ash contains 50 wt % to 60 wt % of SiO2, 20 wt % to 30 wt % of Al₂O₃, and the coal bottom ash contains 40 wt % to 55 wt % of SiO2, 10 wt % to 25 wt % of Al₂O₃.

Aspect 4: The zeolite prepared from coal ash according to any one of the preceding aspects, wherein the coal fly ash has a specific surface area of 0.5 m²/g to 1.5 m²/g, and the coal bottom ash has a specific surface area of 0.6 m²/g to 1.6 m²/g.

Aspect 5: The zeolite prepared from coal ash according to any one of the preceding aspects, wherein the coal fly ash has a Si/Al ratio of 1.3 to 2.0, preferably 1.5 to 1.8, and more preferably about 1.7; and the coal bottom ash has a Si/Al ratio of 1.5 to 2.2, preferably 1.6 to 2.0, and more preferably about 1.8.

Aspect 6: The zeolite prepared from coal ash according to any one of Aspects 1 to 5, wherein the zeolite is prepared from coal fly ash, the zeolite has a particle size of 0.01 μm to 0.50 μm, preferably 0.02 μm to 0.4 μm, more preferably 0.031 μm to 0.396 μm, and even more preferably about 0.12 μm; and the zeolite has a Si/Al ratio of 1.7 to 1.9, preferably about 1.8.

Aspect 7: The zeolite prepared from coal ash according to any one of Aspects 1 to 5, wherein the zeolite is prepared from coal bottom ash, the zeolite has a particle size of 0.01 μm to 1.5 μm, preferably 0.02 μm to 1.0 μm, more preferably 0.035 μm to 0.856 μm, and even more preferably about 0.22 μm; and the zeolite has a Si/Al ratio of 1.1 to 1.3, preferably about 1.2.

Aspect 8: A method for preparing the zeolite according to any one of the preceding aspects, comprising the following steps:
mixing coal fly ash and/or coal bottom ash with a sodium hydroxide solution, stirring and aging at 60° C. to 80° C. for 1 to 2 hours to obtain a sodium hydroxide-treated sample;
melting the sodium hydroxide-treated sample by hydrothermal treatment at 130° C. to 150° C. for 45 to 50 hours to obtain a hydrothermally treated sample, wherein the hydrothermal treatment is performed without stirring the sodium hydroxide-treated sample;
washing, filtering, and drying the hydrothermally treated sample.

Aspect 9: A ceramic membrane prepared by 3D printing technology, comprising compounds Al₂O₃·2SiO₂ and/or Na₈[AlSiO₄]₆(OH)₂, or hydrates thereof;
the ceramic membrane has an overall thickness of 0.01 cm to 1.5 cm, preferably 0.05 cm to 1.0 cm, and more preferably 0.1 cm to 0.3 cm; and the ceramic membrane contains 70 wt % to 85 wt % of silicon, preferably 75 wt % to 85 wt %, and more preferably about 80 wt %.

Aspect 10: The ceramic membrane prepared by 3D printing technology according to Aspect 9, wherein the ceramic membrane has a contact angle of 60 degrees to 110 degrees.

Aspect 11: The ceramic membrane prepared by 3D printing technology according to

Aspect 9, wherein the ceramic membrane has a contact angle of 110 degrees to 140 degrees.

Aspect 12: The ceramic membrane prepared by 3D printing technology according to any one of the preceding aspects, wherein the ceramic membrane is a disc-shaped self-supported membrane with at least one patterned disc surface. Preferably, the patterning on the disc surface may include shapes of circular, elliptical, triangular, rectangular, honeycomb, and polygonal shapes.

Aspect 13: The ceramic membrane prepared by 3D printing technology according to any one of the preceding aspects, wherein each layer of the ceramic membrane has a 3D printed thickness of 5 μm to 500 μm, preferably 10 μm to 100 μm, and more preferably 10 μm to 50 μm.

Aspect 14: The ceramic membrane according to any one of Aspects 9 to 13, wherein the ceramic membrane is prepared from coal fly ash, the ceramic membrane has pores at 850°0 C. to 1050° C., with pore sizes ranging from 1.0 μm to 1.8 μm, preferably from 1.1 μm to 1.6 μm.

Aspect 15: The ceramic membrane according to Aspect 14, wherein the ceramic membrane has a porosity of 75% to 80% at 900° C., preferably from 76% to 78%.

Aspect 16: The ceramic membrane according to any one of Aspects 9 to 13, wherein the ceramic membrane is prepared from coal bottom ash, the ceramic membrane has pores at 850° C. to 1050° C., with pore sizes ranging from 0.3 μm to 1.0 μm, preferably from 0.5 μm to 0.7 μm.

Aspect 17: The ceramic membrane according to Aspect 16, wherein the ceramic membrane has a porosity of 70% to 78% at 900° C., preferably from 74% to 76%.

Aspect 18: The ceramic membrane according to any one of Aspects 9 to 13, wherein

the ceramic membrane is prepared from zeolite containing hydroxy-sodalite, and the ceramic membrane is non-porous.

Aspect 19: The ceramic membrane according to any one of the preceding aspects, wherein the ceramic membrane is applicable in microbial fuel cells, wastewater treatment, or ultrafiltration systems.

Aspect 20: A method for preparing the ceramic membrane according to any one of the preceding aspects, comprising steps of:
mixing silicon-aluminum-based material, photopolymer resin, solvent, dispersant, and pigment to form a mixture, wherein the silicon-aluminum-based material is at least one selected from coal fly ash, coal bottom ash, zeolite according to any one of Aspects 1 to 7, and combinations thereof;
ball milling the mixture to form a ball-milled mixture;
exposing the ball-milled mixture to light for photocuring 3D printing to form a printed product, and drying the printed product.

Aspect 21: The method for preparing the ceramic membrane according to Aspect 20, further comprising debinding and sintering the printed product:
the sintering is performed under a temperature ranging from 700° C. to 1100° C.

Aspect 22: The method for preparing the ceramic membrane according to any one of the preceding aspects, wherein the dispersant has an amount of 0.55 wt % to 3.22 wt % of the mixture, preferably 0.7 wt % to 2.0 wt %, and more preferably about 1.1 wt %.

Aspect 23: The method for preparing the ceramic membrane according to any one of the preceding aspects, wherein the silicon-aluminum-based materials has a total amount of 60 wt % to 75 wt % of the mixture, preferably 65 wt % to 70 wt %, and more preferably about 68 wt %.

Aspect 24: The method for preparing the ceramic membrane according to any one of the preceding aspects, wherein the photocuring 3D printing is performed using Solvent-based Slurry Stereolithography.

Aspect 25: The method for preparing the ceramic membrane according to any one of Aspects 20 to 24, wherein the silicon-aluminum-based material is coal fly ash;
the mixture has a viscosity of 1.5 Pa.s to 3.0 Pa.s, preferably 2.11 Pa.s.

Aspect 26: The method for preparing the ceramic membrane according to Aspect 25, wherein the ball-milled mixture is exposed to light with a light exposure time of 0.5 seconds to 2 seconds, preferably about 1.2 seconds.

Aspect 27: The method for preparing the ceramic membrane according to Aspect 25, wherein the sintering is performed under a temperature ranging from 750° C. to 1100° C., preferably 800° C. to 1100° C., and more preferably 900° C. to 1000° C.

Aspect 28: The method for preparing the ceramic membrane according to any one of Aspects 20 to 24, wherein the silicon-aluminum-based material is coal bottom ash;
the mixture has a viscosity of 2.0 Pa.s to 3.5 Pa.s, preferably 2.81 Pa.s.

Aspect 29: The method for preparing the ceramic membrane according to Aspect 28, wherein the ball-milled mixture is exposed to light with a light exposure time of 2 seconds to 6 seconds, preferably about 4 seconds.

Aspect 30: The method for preparing the ceramic membrane according to Aspect 28, wherein the sintering is performed under a temperature ranging from 700° C. to 1100° C., preferably 800°° C. to 1000° C., and more preferably 850° C. to 950° C.

Aspect 31: The method for preparing the ceramic membrane according to any one of Aspects 20, 22 to 24, wherein the silicon-aluminum-based material is the zeolite according to Aspect 6;
the mixture has a viscosity of 4.0 Pa.s to 5.5 Pa.s, preferably 4.67 Pa.s.

Aspect 32: The method for preparing the ceramic membrane according to Aspect 31, wherein the ball-milled mixture is exposed to light with a light exposure time of 4 seconds to 8 seconds, preferably about 6 seconds.

Aspect 33: The method for preparing the ceramic membrane according to any one of Aspects 20, 22 to 24, wherein the silicon-aluminum-based material is the zeolite according to Aspect 7;
the mixture has a viscosity of 2.5 Pa.s to 4.0 Pa.s, preferably 3.2 Pa.s.

Aspect 34: The method for preparing the ceramic membrane according to Aspect 33, wherein the ball-milled mixture is exposed to light with an light exposure time of 6 seconds to 10.5 seconds, preferably about 8.5 seconds.

Aspect 35: The method for preparing the ceramic membrane according to any one of the preceding aspects, further comprising steps for altering hydrophilicity/hydrophobicity of the ceramic membrane:
dipping the ceramic membrane in a solution comprising polydimethylsiloxane and chloromethylsilane, drying, then dipping the ceramic membrane in the solution again, followed by drying at room temperature.

Aspect 36: The method for preparing the ceramic membrane according to any one of the preceding aspects, wherein the polydimethylsiloxane has a concentration of 0.01 wt % to 20.00 wt % in the solution.

The method for preparing the ceramic membrane according to Aspect 20, wherein the mixture comprises 68.14 wt % of coal fly ash and/or coal bottom ash, 21.37 wt % of the photopolymer resin (ULC F6), 9.35 wt % of methanol, 1.09 wt % of the dispersant (model number 243), and 0.04 wt % of an orange pigment.

The terms used in this specification are for the purpose of describing particular embodiments only and is not intended to limit the present disclosure. As used in the present disclosure, the singular forms “a”, “an” and “the” do not imply a limitation on quantity and should be interpreted as including the plural form unless the context explicitly indicates otherwise.

All ranges disclosed in the present disclosure encompass the endpoints and all combinations of endpoints and intermediate values. The term “combinations thereof” includes one or more of the listed elements and is inclusive. It should also be understood that, as used in this specification, the term “comprising” specifies the presence of stated features, components, steps, and/or elements, but does not preclude the presence or addition of one or more other features, components, steps, elements, and/or combinations thereof.

The term “aspect” refers to the relevant description of the aspect that may be included in at least one aspect of the present disclosure and may or may not be present in other aspects.

While preferred embodiments have been described, it should be understood that those skilled in the art, now and in the future, can make various improvements and modifications that fall within the scope of the appended claims. These claims should be interpreted to maintain proper protection for the original disclosure.

What is claimed is:

1. A ceramic membrane prepared by 3D printing technology, comprising compounds Al₂O₃·2SiO₂ and/or Na₈[AlSiO₄]₆(OH)₂, or hydrates thereof;
the ceramic membrane has an overall thickness of 0.01 cm to 1.5 cm, and contains 70 wt % to 85 wt % of silicon.

2. The ceramic membrane prepared by 3D printing technology according to claim 1, wherein the ceramic membrane has a porosity of 70% to 80% at 900° C.

3. The ceramic membrane prepared by 3D printing technology according to claim 1, wherein the ceramic membrane has a contact angle of 60 degrees to 110 degrees.

4. The ceramic membrane prepared by 3D printing technology according to claim 1, wherein the ceramic membrane has a contact angle of 110 degrees to 140 degrees.

5. The ceramic membrane prepared by 3D printing technology according to claim 1, wherein the ceramic membrane is a disc-shaped self-supported membrane with at least one patterned disc surface.

6. The ceramic membrane prepared by 3D printing technology according to claim 1, wherein the ceramic membrane is applicable in microbial fuel cells, wastewater treatment, and ultrafiltration systems.

7. A method for preparing the ceramic membrane according to claim 1, comprising steps of:
mixing silicon-aluminum-based material, photopolymer resin, solvent, dispersant, and pigment to form a mixture, wherein the silicon-aluminum-based material is at least one selected from coal fly ash, coal bottom ash, zeolite containing hydroxy-sodalite, and combinations thereof;
ball milling the mixture to form a ball-milled mixture;
exposing the ball-milled mixture to light for photocuring 3D printing to form a printed product, and drying the printed product.

8. The method for preparing the ceramic membrane according to claim 7, further comprising debinding and sintering the printed product:
the sintering is performed under a temperature ranging from 700° C. to 1100° C.

9. The method for preparing a ceramic membrane according to claim 7, further comprising a step of preparing the zeolite containing hydroxy-sodalite prior to all steps:
mixing coal fly ash and/or coal bottom ash with a sodium hydroxide solution, stirring and aging at 60° C. to 80° C. for 1 to 2 hours to obtain a sodium hydroxide-treated sample;
melting the sodium hydroxide-treated sample by hydrothermal treatment at 130° C. to 150° C. for 45 to 50 hours to obtain a hydrothermally treated sample, wherein the hydrothermal treatment is performed without stirring the sodium hydroxide-treated sample;
washing, filtering, and drying the hydrothermally treated sample to obtain the zeolite containing hydroxy-sodalite.

10. The method for preparing the ceramic membrane according to claim 7, wherein the dispersant has an amount of 0.55 wt % to 3.22 wt % of the mixture.

11. The method for preparing the ceramic membrane according to claim 7, wherein the silicon-aluminum-based materials has a total amount of 60 wt % to 75 wt % of the mixture.

12. The method for preparing the ceramic membrane according to claim 7, wherein the photocuring 3D printing is performed using Solvent-based Slurry Stereolithography.

13. The method for preparing the ceramic membrane according to claim 7, further comprising steps for altering hydrophilicity/hydrophobicity of the ceramic membrane:
dipping the ceramic membrane in a solution comprising polydimethylsiloxane and chloromethylsilane, drying, then dipping the ceramic membrane in the solution again, followed by drying at room temperature.

14. The method for preparing the ceramic membrane according to claim 7, wherein the polydimethylsiloxane has a concentration of 0.01 wt % to 20.00 wt % in the solution.

15. The method for preparing the ceramic membrane according to claim 7, wherein the mixture comprises 68.14 wt % of coal fly ash and/or coal bottom ash, 21.37 wt % of the photopolymer resin, 9.35 wt % of methanol, 1.09 wt % of the dispersant, and 0.04 wt % of an orange pigment.
